(19) United States
(12) Patent Application Publication
(10) Pub. No.: US 2019/0368435 A1
(43) Pub. Date: Dec. 5, 2019

(54) HIGH PRESSURE EGR FLOW MODEL HYBRID STRATEGY

(71) Applicant: GM Global Technology Operations LLC, Detroit, MI (US)

(72) Inventors: Nicola Totaro, Torino (IT); Andrea Dutto, Torino (IT); Giorgio Sticchi, Maglie (IT)

(73) Assignee: GM Global Technology Operations LLC, Detroit, MI (US)

(21) Appl. No.: 15/994,051

(22) Filed: May 31, 2018

(51) Int. Cl. F02D 41/00; F02D 13/02; F02D 41/14

(52) U.S. Cl. CPC F02D 41/0072; F02D 13/0203; F02D 23/02; F02D 41/005; F02D 41/1406; F02D 41/0007

(57) ABSTRACT

A method to control an internal combustion engine including exhaust gas recirculation (EGR) system and an air charging system includes the following steps: (a) determining, via an engine controller, a first EGR mass flow rate using an orifice model; (b) determining, via the engine controller, a second EGR mass flow rate using a cylinder volumetric efficiency model; (c) determining, via the engine controller, a hybrid EGR mass flow rate based on the first EGR flow rate and the second EGR flow rate; and (d) controlling the air charging system based on the hybrid EGR flow rate.

### INTRODUCTION

The present disclosure relates a hybrid pressure exhaust gas recirculation (EGR) flow model strategy.

EGR flow is a parameter that can be controlled by engine controls. An exhaust gas flow within the exhaust system of an engine is depleted of oxygen and is essentially an inert gas. When introduced to or retained within a combustion chamber in combination with a combustion charge of fuel and air, the exhaust gas moderates the combustion, reducing an output and an adiabatic flame temperature. EGR can also be controlled in combination with other parameters in advanced combustion strategies, for example, including homogeneous charge compression ignition (HCCI) combustion. EGR can also be controlled to change properties of the resulting exhaust gas flow. Engine control methods control EGR in order to control the resulting combustion within the engine and the resulting output of the engine.

Air handling systems for an engine manage the flow of intake air and EGR into the engine. Air handling systems must be equipped to meet charge air composition targets (e.g. an EGR fraction target) to achieve emissions targets, and meet total air available targets (e.g. the charge mass flow) to achieve desired power and torque targets. The actuators that most strongly affect EGR flow generally affect charge flow, and the actuators that most strongly affect charge flow generally affect EGR flow. Therefore, an engine with a modern air handling system presents a multiple input multiple output (MIMO) system with coupled input-output response loops. Aside from achieving the desired EGR fraction to meet emission and performance, it is also desirable to know with sufficient accuracy the amount of EGR fraction to properly estimate the engine emissions. Those estimations are then used to control and diagnose the after-treatment system.

### SUMMARY

The present disclosure relates to a method for determining (i.e., estimating) an EGR mass flow rate in a high pressure EGR conduit of an EGR system. By using the presently disclosed method, an engine controller employs a robust EGR hybrid flow model strategy that combines two independent flow models. The combination is done according to robustness characterization of the two models, evaluating in the current operating conditions.

In certain embodiments, the method includes the following steps: (a) determining, via an engine controller, a first EGR mass flow rate using an orifice model; (b) determining, via the engine controller, a second EGR mass flow rate using a cylinder volumetric efficiency model; (c) determining, via the engine controller, a hybrid EGR mass flow rate based on the first EGR flow rate and the second EGR flow rate; and (d) controlling the air charging system based on the hybrid EGR flow rate.

Further, the method may also include determining an exhaust manifold temperature, determining an intake manifold pressure, determining an exhaust manifold pressure, and determining a position of a first EGR valve of the EGR system. The first EGR mass flow rate is a function of the position of the first EGR valve, the exhaust manifold temperature, the intake manifold pressure, and the exhaust manifold pressure. The first EGR mass flow rate is calculated by using the following equations:

$${\dot{m}}_{{HPE}_{Orif}} = {CdA}_{{egr}_{HP}} ( {u}_{{egr}_{HP}} ) \frac{{p}_{x}}{\sqrt{{RT}_{x}}} ξ ( \frac{{p}_{i}}{{p}_{x}} ) ; and$$

$$ξ ( \frac{{p}_{i}}{{p}_{x}} ) = \{ \begin{matrix}\sqrt{\frac{2 γ}{γ - 1} ( {p}_{r}^{2 / γ} - {p}_{r}^{( γ + 1 ) / γ} )} & \frac{{p}_{i}}{{p}_{x}} > 0.5292 \\ {γ}^{\frac{1}{2}} {\frac{2 γ}{γ + 1} }^{\frac{γ + 1}{2 ( γ - 1 )}} & \frac{{p}_{i}}{{p}_{x}} \leq 0.5292\end{matrix}$$

where:
\dot{m}_{HPE}_{_{Orif}} is the first EGR mass flow rate;
pₓ is the exhaust manifold pressure;
pᵢ is the intake manifold pressure;
Tₓ is the exhaust manifold temperature;
R is ideal gas constant; and
CdA_{egr}_{_{HP}}(u_{egr}_{_{HP}}) is a variable that is a function of the position of the first EGR valve; and
γ is a heat capacity ratio.

The method may further include determining a throttle mass flow rate and a total cylinder mass flow rate. The second EGR mass flow rate is a function of the throttle mass flow rate and the total cylinder mass flow rate. The second EGR mass flow rate may be expressed as:

\dot{m}_{HPE}_{_{VolEff}}=\dot{m}_{CylTot}−\dot{m}_{Throt}
where:
\dot{m}_{HPE}_{_{VolEff}} is the second EGR mass flow rate;
\dot{m}_{CylTot} is the total cylinder mass flow rate; and
\dot{m}_{Throt} is the throttle mass flow rate.

The method may further include determining an orifice based EGR rate. Such orifice based EGR rate is expressed as:

$$\frac{{\dot{m}}_{{HPE}_{Orif}}}{{\dot{m}}_{{HPE}_{Orif}} + {\dot{m}}_{Throt}}$$

where:
\dot{m}_{HPE}_{_{Orif}} is the first EGR mass flow rate;
and
\dot{m}_{Throt} is the throttle mass flow rate.

The method may further include determining a hybrid weight factor as a function of the EGR rate. The hybrid EGR mass flow rate is expressed as follows:

\dot{m}_{HPE}_{_{Hyb}}=K_{Hyb}\dot{m}_{HPE}_{_{Orif}}+(1−K_{Hyb})\dot{m}_{HPE}_{_{VolEff}}
where:
K_{Hyb} is the Hybrid Weight Factor and is a function of the orifice based EGR rate described above;
\dot{m}_{HPE}_{_{Orif}} is the first EGR mass flow rate; and
\dot{m}_{HPE}_{_{VolEff}} is the second EGR mass flow rate.

The method may further include controlling the air charging system based on the hybrid EGR flow rate includes controlling a throttle valve of the air charging system based on the hybrid EGR flow rate.

The present disclosure also describes an internal combustion engine. The engine includes an engine block defining a plurality of cylinders, an air charging system in fluid communication with the plurality of cylinders, wherein the air charging system includes a throttle valve, an exhaust gas recirculation (EGR) system in fluid communication with the air charging system, and an engine controller in electronic communication with the throttle valve. The engine controller is programmed to execute the method described above.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a vehicle including an internal combustion engine and an exhaust gas recirculation system.

FIG. 2 is a flowchart of a method for controlling the exhaust gas recirculation system.

### DETAILED DESCRIPTION

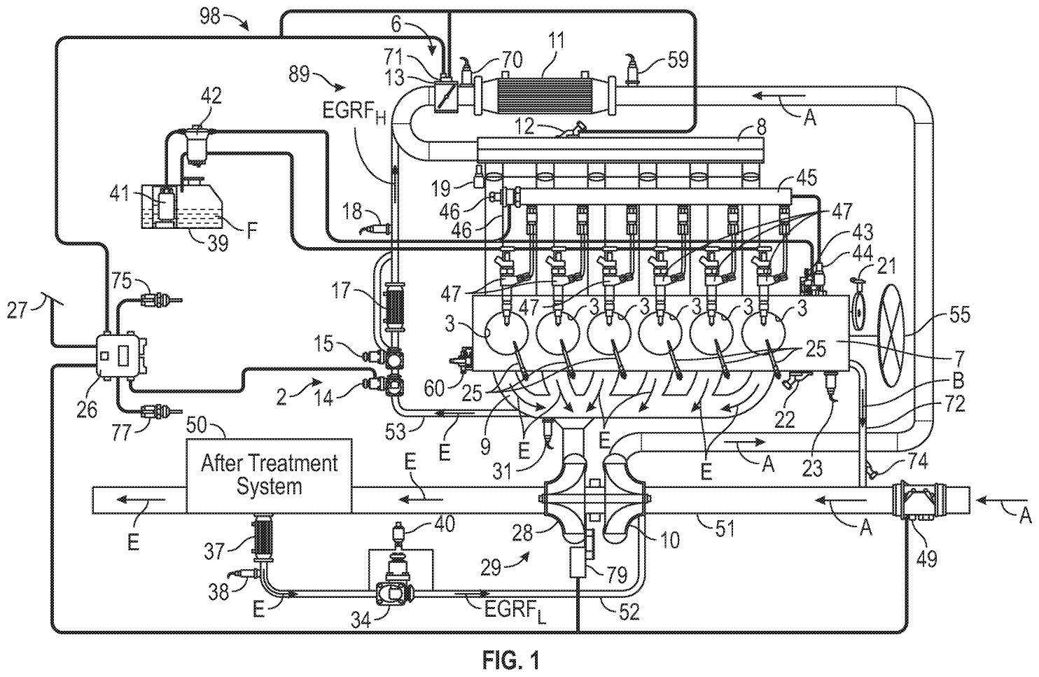

Referring now to the drawings, wherein the depictions are for the purpose of illustrating certain exemplary embodiments only and not for the purpose of limiting the same, FIG. 1 schematically illustrates a vehicle 98 including an internal combustion engine (engine) 100, such as a gasoline engine or a diesel engine. The engine 89 includes an exhaust aftertreatment system 50 that is arranged in accordance with an embodiment of this disclosure. The exhaust aftertreatment system 50 includes a plurality of fluidly connected exhaust purifying devices for purifying engine exhaust gas prior to expulsion to ambient air. The engine 89 may be a multi-cylinder internal combustion engine that combusts a mixture of directly-injected fuel, intake air and recirculated exhaust gas to generate mechanical power. The engine 89 is configured to operate with compression-ignition combustion, although the concepts described herein may be employed on other engine configurations that employ heated exhaust gas sensors such as lambda or NOx sensors and execute post-combustion fuel injection to heat exhaust purifying devices of an exhaust aftertreatment system. The engine 89 may be incorporated to the vehicle 98, which may be, for example, a passenger car, truck, agricultural vehicle or a construction vehicle, a marine vehicle. Alternatively, the engine 89 may be implemented on a stationary setting, e.g., coupled to an electric power generator.

The engine 89 includes a multi-cylinder engine block 7, an intake manifold 8 for channeling intake air A to the cylinders 3 of the engine 89, and an exhaust manifold 9 for directing the flow of exhaust gases E from the engine 89 to the exhaust aftertreatment system 50. The engine 89 may additionally include other engine components and systems, such as pistons, crankshaft, engine head(s), intake valves, exhaust valves, camshaft(s), and variable cam phasers. The engine 89 may operate in a four-stroke combustion cycle of repetitively-executed strokes of intake-compression-combustion-exhaust. A variable geometry turbocharger (VGT) 29 includes a turbine 28 that fluidly couples to the exhaust manifold 9 upstream of the exhaust aftertreatment system 50. The engine 89 includes a plurality of direct-injection fuel injectors 47 that are arranged to directly inject fuel into individual combustion chambers. The injectors 47 may be a suitable direct-injection device, and may be solenoid-activated devices. Fuel F is supplied to the fuel injectors 47 from a fuel storage tank 39 via a low-pressure fuel pump 41, a fuel filter assembly 42, a high-pressure fuel pump 43, a fuel rail 45, a fuel pressure regulating valve 46, and pressure control valves 44. Each of the engine cylinders 3 may include a glow plug 25. The engine 89 includes an air charging system 6, which may include a mass air flow (MAF) sensor 49, a compressor 10 of the VGT 29, a charge air cooler 11, a throttle valve 13, a temperature and manifold absolute pressure (TMAP) sensor 12 for monitoring boost pressure and intake air temperature, and other sensing devices as may be useful. The throttle valve 13 includes a throttle valve position sensor 71 to determine the position of the throttle valve 13. The engine 89 further includes a cooler inlet temperature sensor 59 for monitoring the temperature of the intake air A upstream of the charge air cooler 11 and a cooler outlet temperature sensor 70 for monitoring the temperature of the intake air A downstream of the charge air cooler 11.

The engine 89 may include an exhaust gas recirculation (EGR) system 2 that fluidly channels the exhaust gases E from the exhaust manifold 9 to the intake manifold 8. In some embodiments, the EGR system 2 may include a first EGR passageway 53 (i.e., the high-pressure conduit) that directs the exhaust gases E from the exhaust manifold 9 to the air intake conduit 51 at a location downstream of the compressor 10. Further, the EGR system 2 includes a second EGR passageway 52 (i.e., the low-pressure conduit) that directs the exhaust gases E from the aftertreatment system 50 to an air intake conduit 51 at a location upstream of the compressor 10. The EGR system 2 also includes a first EGR valve 14 (i.e., a high-pressure EGR valve), a first EGR cooler 17 (e.g., a high-pressure EGR cooler), a bypass valve 15 for bypassing the first EGR cooler 17, and an EGR-cooler outlet temperature sensor 18 each coupled along the first EGR passageway 53. An exhaust manifold temperature sensor 31 is coupled to the exhaust manifold 9 to monitor the temperature of the exhaust gases E flowing through the exhaust manifold 9 (and flowing into the first EGR passageway 53). The EGR system 2 also includes a second EGR valve 34 (i.e., a low-pressure EGR valve), a second EGR cooler 37 (e.g., a low-pressure EGR cooler), an EGR-cooler outlet temperature sensor 38, and a delta pressure sensor 40 (for monitoring pressure drop across the second EGR valve 34) each coupled along the second EGR passageway 52. Other engine monitoring sensors may include a crankshaft position sensor 21, an oil temperature sensor 23 coupled to the engine block 7, and an oil pressure sensor 22 coupled to the engine block 7, among others. One or more engine monitoring sensors may be replaced with a suitable executable model. The engine 89 also includes a continuous variable displacement oil pump 60 coupled to the engine block 7 and a mechanical cooling fan 55 driven by power generated by the engine 89. The engine 89 further includes a vent passageway 72 to direct blow-by gases B (i.e., unburned gases) from the engine block 7 to the air intake conduit 51. A ventilation pressure sensor 74 is coupled to the vent passageway 72 to monitor the temperature of the blow-by gases B. The vehicle 98 further includes an outside air temperature sensor 75 for monitoring outside air temperature and a barometric pressure sensor 77 for monitoring the atmospheric pressure. The barometric pressure sensor 77 may be integrated with an engine controller 26.

The engine controller 26 monitors various sensing devices and executes control routines to command various actuators to control operation of the engine 89 in response to operator commands. Operator commands may be determined from various operator input devices, including, e.g., a pedal assembly 27 that includes, by way of example, an accelerator pedal and a brake pedal. Other sensing devices associated with engine operation may include, by way of example only, the barometric pressure sensor 77, the ambient air temperature sensor 75, a VGT position sensor 79, the exhaust gas temperature sensor 31, among others.

The terms controller, control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean a controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals, for example each 100 microseconds or 3.125, 6.25, 12.5, 25 and 100 milliseconds during ongoing operation. Alternatively, routines may be executed in response to occurrence of a triggering event. Communications between controllers and between controllers, actuators and/or sensors may be accomplished using a direct wired link, a networked communications bus link, a wireless link or other suitable communications link. Communications includes exchanging data signals in a suitable form, including, for example, electrical signals via a conductive medium, electromagnetic signals via air, optical signals via optical waveguides, and the like. Data signals may include signals representing inputs from sensors, signals representing actuator commands, and communications signals between controllers. The term ‘model’ refers to a processor-based or processor-executable code and associated calibration that simulates a physical existence of a device or a physical process. As used herein, the terms ‘dynamic’ and ‘dynamically’ and related terms describe steps or processes that are executed in real-time and are characterized by monitoring or otherwise determining states of parameters and regularly or periodically updating the states of the parameters during execution of a routine or between iterations of execution of the routine. In one embodiment, this includes as follows.

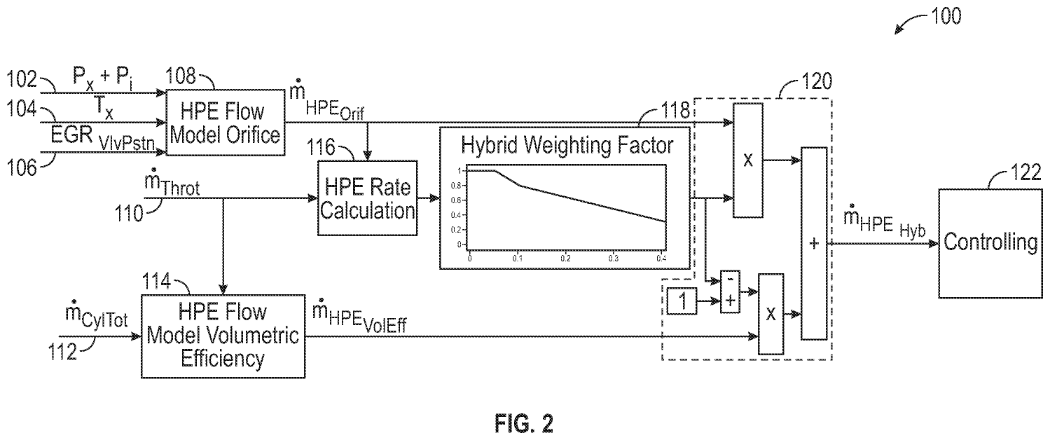

With reference to FIGS. 1 and 2, the engine controller 26 is specially programmed to execute the method 100 in order to determine (i.e., estimate) an EGR mass flow rate in the first EGR passageway 53 (i.e., the high-pressure conduit) of the EGR system 2. In other words, using the the method 100, the engine controller 26 employs a robust EGR hybrid flow model strategy that combines two independent flow models. The combination is done according to robustness characterization of the two models, evaluating in the current operating conditions. The method 100 begins at step 102, in which the engine controller 26 determines the pressure of the exhaust gases E in the intake manifold 8 (i.e., the intake manifold pressure pᵢ). To do so, the engine controller 26 may receive a signal from the TMAP sensor 12. The TMAP sensor 12 is coupled to the intake manifold 8 and is configured to measure and monitor the intake manifold pressure pᵢ. Further, the TMAP sensor 12 is in electronic communication with the engine controller 26 and is configured to send the signal to the engine controller 26. Also at step 102, the engine controller 26 determines the pressure of the exhaust gases E in the exhaust manifold 9 (i.e., the exhaust manifold pressure pₓ). To do so for example, the engine controller 26 may receive a signal from the exhaust manifold temperature sensor 31 and then determine the exhaust manifold pressure pₓ based the volume of the exhaust manifold 9 and the temperature of the exhaust gases E in the exhaust manifold 9 (i.e., the exhaust manifold temperature Tₓ) using the ideal gas equation or a calibration look-up table. Other models could be used to estimate the exhaust manifold pressure pₓ. The exhaust manifold temperature sensor 31 is coupled to the exhaust manifold 9 and is configured to measure and monitor the exhaust manifold temperature Tₓ. The exhaust manifold temperature Tₓ could be estimated using a model. The engine controller 26 is in electronic communication with the exhaust manifold temperature sensor 31 and therefore receives signals from the exhaust manifold temperature sensor 31 that are indicative of the exhaust manifold temperature Tₓ.

The method 100 also includes step 104, which entails determining the exhaust manifold temperature Tₓ. As discussed above, the engine controller 26 determines the exhaust manifold temperature Tₓ based, for example, on signals received from the exhaust manifold temperature sensor 31.

The method 100 also includes step 106, which entails determining the position of the first EGR valve 14 (i.e., EGR_{Vlvpstn}). The engine controller 26 is in electronic communication with the first EGR valve 14. Accordingly, the engine controller 26 is therefore configured to determine the position EGR_{Vlvpstn} of the first EGR valve 14 based on signals received from the first EGR valve 14.

After determining the position EGR_{Vlvpstn} of the first EGR valve 14, the exhaust manifold temperature Tₓ, the intake manifold pressure pᵢ, and the exhaust manifold pressure pₓ, the method 100 proceeds to step 108. At step 108, the engine controller 26 determines (i.e., estimates) a first EGR mass flow rate \dot{m}_{HPE}_{_{Orif}} using an orifice model (i.e., High Pressure Exhaust (HPE) Flow Model Orifice). At step 108, the engine controller 26 determines (i.e., estimates) the first EGR mass flow rate \dot{m}_{HPE}_{_{Orif}} based on (or as a function of) the position EGR_{Vlvpstn} of the first EGR valve 14, the exhaust manifold temperature Tₓ, the intake manifold pressure pᵢ, and the exhaust manifold pressure pₓ using, for example, a calibrated look-up table. Alternatively, the engine controller 26 calculates the first EGR mass flow rate \dot{m}_{HPE}_{_{Orif}} using the HPE Flow Model Orifice, which is expressed by the following equations:

$${\dot{m}}_{{HPE}_{Orif}} = {CdA}_{{egr}_{HP}} ( {u}_{{egr}_{HP}} ) \frac{{p}_{x}}{\sqrt{{RT}_{x}}} ξ ( \frac{{p}_{i}}{{p}_{x}} )$$

$$ξ ( \frac{{p}_{i}}{{p}_{x}} ) = \{ \begin{matrix}\sqrt{\frac{2 γ}{γ - 1} ( {p}_{r}^{2 / γ} - {p}_{r}^{( γ + 1 ) / γ} )} & \frac{{p}_{i}}{{p}_{x}} > 0.5292 \\ {γ}^{\frac{1}{2}} {\frac{2 γ}{γ + 1} }^{\frac{γ + 1}{2 ( γ - 1 )}} & \frac{{p}_{i}}{{p}_{x}} \leq 0.5292\end{matrix}$$

where:
\dot{m}_{HPE}_{_{Orif}} is the first EGR mass flow rate;
pₓ is the exhaust manifold pressure;
pᵢ is the intake manifold pressure;
Tₓ is the exhaust manifold temperature;
R is ideal gas constant; and
CdA_{egr}_{_{HP}}(u_{egr}_{_{HP}}) is a variable that is a function of the position EGR_{VlvPstn} of the first EGR valve 14 and is determined using a calibrated look-up table; and
γ is a heat capacity ratio.

The method 100 also includes step 110, which entails determining the mass flow rate of the gas flowing through the throttle valve 13 (i.e., the throttle mass flow rate \dot{m}_{Throt}) The engine controller 26 determines the throttle mass flow rate \dot{m}_{Throt} based on the mass flow rate of air entering the engine 89 (as measured by the MAF sensor 49) plus the mass flow rate of the exhaust gases E flowing through the second EGR passageway 52 (which may be, for example, indirectly determined based on signals from the delta pressure sensor 40). The mass flow rate of the exhaust gases E flowing through the second EGR passageway 52 may be determined using other methods.

The method 100 also includes step 112, which entails determining the total mass flow rate of the gas in all the cylinders 3 (i.e., the total cylinder mass flow rate \dot{m}_{CylTot}) To do so, the engine controller 26 determines the total cylinder mass flow rate \dot{m}_{CylTot} from a calibrated look-up table that is generated through vehicle testing.

After determining the total cylinder mass flow rate \dot{m}_{CylTot} and the throttle mass flow rate \dot{m}_{Throt}, the method 100 proceeds to step 114. At step 114, the engine controller 26 determines a second EGR mass flow rate \dot{m}_{HPE}_{_{VolEff}} using a cylinder volumetric efficiency model (i.e., the HPE Flow Volumetric Efficiency Model). For instance, the engine controller 26 determines the second EGR mass flow rate \dot{m}_{HPE}_{_{VolEff}} based on the total cylinder mass flow rate \dot{m}_{CylTot} and the throttle mass flow rate \dot{m}_{Throt} using, for example, a calibrated look-up table. Alternatively, the engine controller 26 calculates the second EGR mass flow rate \dot{m}_{HPE}_{_{VolEff}} using the HPE Flow Volumetric Efficiency Model, which is expressed by the following equation:

\dot{m}_{HPE}_{_{VolEff}}=\dot{m}_{CylTot}−\dot{m}_{Throt}
where:
\dot{m}_{HPE}_{_{VolEff}} is the second EGR mass flow rate;
\dot{m}_{CylTot} is the total cylinder mass flow rate; and
\dot{m}_{Throt} is the throttle mass flow rate.

The method 100 also includes step 116, which entails determining an orifice based EGR rate (i.e., the HPE Rate Calculation). At step 116, the engine controller 26 determines (i.e., calculates) the orifice based EGR rate using the following equation:

$$Orifice Based EGR rate = \frac{{\dot{m}}_{{HPE}_{Orif}}}{{\dot{m}}_{{HPE}_{Orif}} + {\dot{m}}_{Throt}}$$

where:
\dot{m}_{HPE}_{_{Orif}} is the first EGR mass flow rate;
\dot{m}_{HPE}_{_{VolEff}} is the second EGR mass flow rate;
\dot{m}_{cylTot} is the total cylinder mass flow rate; and
\dot{m}_{Throt} is the throttle mass flow rate.

At step 118, the method 100 also determines a Hybrid Weight Factor K_{Hyb} based on (i.e., as a function of) the orifice based EGR rate. In other words, the engine controller 26 determines Hybrid Weight Factor K_{Hyb}, which is expressed as follows:

$${K}_{Hyb} = f ( \frac{{\dot{m}}_{{HPE}_{Orif}}}{{\dot{m}}_{{HPE}_{Orif}} + {\dot{m}}_{Throt}} )$$

where:
K_{Hyb} is the Hybrid Weight Factor;
m̅_{HPE}_{_{Orif}} is the first EGR mass flow rate;

\dot{m}_{HPE}_{_{VolEff}} is the second EGR mass flow rate;
\dot{m}_{CylTot} is the total cylinder mass flow rate; and
\dot{m}_{Throt} is the throttle mass flow rate

At step 118, the engine controller 26 determines the Hybrid Weight Factor K_{Hyb} from a calibrated look-up table, which is developed through testing activity. Stated differently, experimental validation is performed through a robustness analysis. Thus, the robustness is evaluated experimentally on engines 100 in different engine operating conditions.

After step 118, the method 100 proceeds step 120, which entails determining a hybrid EGR mass flow rate \dot{m}_{HPE}_{_{Hyb}} based on the first EGR mass flow rate \dot{m}_{HPE}_{_{Orif}} and the second EGR mass flow rate \dot{m}_{HPE}_{_{VolEff}}. To do, the engine controller 26 calculates the hybrid EGR mass flow rate \dot{m}_{HPE}_{_{Hyb}} using the following equation:

\dot{m}_{HPE}_{_{Hyb}}=K_{Hyb}\dot{m}_{HPE}_{_{Orif}}+(1−K_{Hyb})\dot{m}_{HPE}_{_{VolEff}}
where:
K_{Hyb} is the Hybrid Weight Factor;
\dot{m}_{HPE}_{_{Orif}} is the first EGR mass flow rate; and
\dot{m}_{HPE}_{_{VolEff}} is the second EGR mass flow rate.

The blocks “+”, “1”, “x” in step 120 represent the numerical values and mathematical operations expressed in the equation above.

After step 120, the method 100 proceeds to step 122. At step 122, the engine controller 26 controls the air charging system 6 based on the hybrid EGR mass flow rate \dot{m}_{HPE}_{_{Hyb}} in three different ways First, the air charging system 6 may solely use the first EGR valve 14 used to control air mass entering the cylinders 3 based on the hybrid EGR mass flow rate \dot{m}_{HPE}_{_{Hyb}} (although the hybrid EGR mass flow rate \dot{m}_{HPE}_{_{Hyb}} is not a direct control variable). In this instance, the throttle valve 13 is wide open. Second, both first EGR valve 14 and throttle valve 13 may be used to control air mass and EGR fraction, in a coordinated method. The throttle valve 13 may be closed to a certain extent to increase the pressure drop across the first EGR passageway 53. Third, both of the options described above are viable also when the second EGR passageway 52 is present; in that case, even if solely the air mass is controlled, the split between first EGR passageway 53 and the first EGR passageway 53 is a control variable, thus using our Hybrid HP EGR model for control purposes.

While the best modes for carrying out the disclosure have been described in detail, those familiar with the art to which this disclosure relates will recognize various alternative designs and embodiments for practicing the disclosure within the scope of the appended claims.

What is claimed is:

1. A method to control an internal combustion engine including exhaust gas recirculation (EGR) system and an air charging system, comprising:
determining, via an engine controller, a first EGR mass flow rate using an orifice model;
determining, via the engine controller, a second EGR mass flow rate using a cylinder volumetric efficiency model;
determining, via the engine controller, a hybrid EGR mass flow rate based on the first EGR flow rate and the second EGR flow rate; and
controlling the air charging system based on the hybrid EGR flow rate.

2. The method of claim 1, further comprising:
determining an exhaust manifold temperature;
determining an intake manifold pressure;
determining an exhaust manifold pressure;
determining a position of a first EGR valve of the EGR system; and
wherein the first EGR mass flow rate is a function of the position of the first EGR valve, the exhaust manifold temperature, the intake manifold pressure, and the exhaust manifold pressure.

3. The method of claim 2, wherein the first EGR mass flow rate is expressed as follows:
$${\dot{m}}_{{HPE}_{Orif}} = {CdA}_{{egr}_{HP}} ( {u}_{{egr}_{HP}} ) \frac{{p}_{x}}{\sqrt{{RT}_{x}}} ξ ( \frac{{p}_{i}}{{p}_{x}} ) ; and$$
$$ξ ( \frac{{p}_{i}}{{p}_{x}} ) = \{ \begin{matrix}\sqrt{\frac{2 γ}{γ - 1} ( {p}_{r}^{2 / γ} - {p}_{r}^{( γ + 1 ) / γ} )} & \frac{{p}_{i}}{{p}_{x}} > 0.5292 \\ {γ}^{\frac{1}{2}} {\frac{2 γ}{γ + 1} }^{\frac{γ + 1}{2 ( γ - 1 )}} & \frac{{p}_{i}}{{p}_{x}} \leq 0.5292\end{matrix}$$
where:
\dot{m}_{HPE}_{_{Orif}} is the first EGR mass flow rate;
pₓ is the exhaust manifold pressure;
pᵢ is the intake manifold pressure;
Tₓ is the exhaust manifold temperature;
R is ideal gas constant; and
CdA_{egr}_{_{Hp}}(u_{egr}_{_{Hp}}) is a variable that is a function of the position of the first EGR valve; and
γ is a heat capacity ratio.

4. The method of claim 3, further comprising determining a throttle mass flow rate.

5. The method of claim 4, further comprising determining a total cylinder mass flow rate.

6. The method of claim 5, wherein the second EGR mass flow rate is a function of the throttle mass flow rate and the total cylinder mass flow rate.

7. The method of claim 6, wherein the second EGR mass flow rate is expressed as:
\dot{m}_{HPE}_{_{VolEff}}=\dot{m}_{CylTot}−\dot{m}_{Throt}
where:
\dot{m}_{HPE}_{_{VolEff}} is the second EGR mass flow rate;
\dot{m}_{CylTot} is the total cylinder mass flow rate; and
\dot{m}_{Throt} is the throttle mass flow rate.

8. The method of claim 7, further comprising determining an orifice based EGR rate, wherein the orifice based EGR rate is expressed as:
$$\frac{{\dot{m}}_{{HPE}_{Orif}}}{{\dot{m}}_{{HPE}_{Orif}} + {\dot{m}}_{Throt}}$$
where:
\dot{m}_{HPE}_{_{Orif}} is the first EGR mass flow rate; and
\dot{m}_{Throt} is the throttle mass flow rate.

9. The method of claim 8, further comprising determining a hybrid weight factor as a function of the orifice based EGR rate.

10. The method of claim 9, wherein the hybrid EGR mass flow rate is expressed as follows:
\dot{m}_{HPE}_{_{Hyb}}=K_{Hyb}\dot{m}_{HPE}_{_{Orif}}+(1−K_{Hyb})\dot{m}_{HPE}_{_{VolEff}}
where:
K_{Hyb} is the Hybrid Weight Factor;
\dot{m}_{HPE}_{_{Orif}} is the first EGR mass flow rate; and
\dot{m}_{HPE}_{_{VolEff}} is the second EGR mass flow rate.

11. The method of claim 10, wherein controlling the air charging system based on the hybrid EGR flow rate includes controlling a throttle valve of the air charging system based on the hybrid EGR flow rate.

12. An internal combustion engine, comprising:
an engine block defining a plurality of cylinders;
an air charging system in fluid communication with the plurality of cylinders, wherein the air charging system includes a throttle valve;
an exhaust gas recirculation (EGR) system in fluid communication with the air charging system; and
an engine controller in electronic communication with the throttle valve, wherein the engine controller is programmed to:
determine a first EGR mass flow rate using an orifice model;
determine a second EGR mass flow rate using a cylinder volumetric efficiency model;
determine a hybrid EGR mass flow rate based on the first EGR flow rate and the second EGR flow rate; and
control the throttle valve of the air charging system based on the hybrid EGR flow rate.

13. The internal combustion engine of claim 12, wherein the engine controller is further programmed to:
determine an exhaust manifold temperature;
determine an intake manifold pressure;
determine an exhaust manifold pressure;
determine a position of a first EGR valve of the EGR system; and
wherein the first EGR mass flow rate is a function of the position of the first EGR valve, the exhaust manifold temperature, the intake manifold pressure, and the exhaust manifold pressure.

14. The internal combustion engine of claim 13, wherein the first EGR mass flow rate is expressed as follows:
$${\dot{m}}_{{HPE}_{Orif}} = {CdA}_{{egr}_{HP}} ( {u}_{{egr}_{HP}} ) \frac{{p}_{x}}{\sqrt{{RT}_{x}}} ξ ( \frac{{p}_{i}}{{p}_{x}} ) ; and$$
$$ξ ( \frac{{p}_{i}}{{p}_{x}} ) = \{ \begin{matrix}\sqrt{\frac{2 γ}{γ - 1} ( {p}_{r}^{2 / γ} - {p}_{r}^{( γ + 1 ) / γ} )} & \frac{{p}_{i}}{{p}_{x}} > 0.5292 \\ {γ}^{\frac{1}{2}} {\frac{2 γ}{γ + 1} }^{\frac{γ + 1}{2 ( γ - 1 )}} & \frac{{p}_{i}}{{p}_{x}} \leq 0.5292\end{matrix}$$
where:
\dot{m}_{HPE}_{_{Orif}} is the first EGR mass flow rate;
pₓ is the exhaust manifold pressure;
pᵢ is the intake manifold pressure;
Tₓ is the exhaust manifold temperature;
R is ideal gas constant; and
CdA_{egr}_{_{HP}}(u_{egr}_{_{HP}}) is a variable that is a function of the position of the first EGR valve; and
γ is a heat capacity ratio.

15. The internal combustion engine of claim 14, wherein the engine controller is further programmed to determine a throttle mass flow rate and a total cylinder mass flow rate.

16. The internal combustion engine of claim 15, wherein the second EGR mass flow rate is a function of the throttle mass flow rate and the total cylinder mass flow rate.

17. The internal combustion engine of claim 16, wherein the second EGR mass flow rate is expressed as:
\dot{m}_{HPE}_{_{VolEff}}=\dot{m}_{CylTot}−\dot{m}_{Throt}
where:
\dot{m}_{HPE}_{_{VolEff}} is the second EGR mass flow rate;
\dot{m}_{CylTot} is the total cylinder mass flow rate; and
\dot{m}_{Throt} is the throttle mass flow rate.

18. The internal combustion engine of claim 17, wherein the engine controller is programmed to calculate an EGR rate, wherein the EGR rate is expressed as:
$$\frac{{\dot{m}}_{{HPE}_{Orif}}}{{\dot{m}}_{{HPE}_{Orif}} + {\dot{m}}_{Throt}}$$
where:
\dot{m}_{HPE}_{_{Orif}} is the first EGR mass flow rate; and
\dot{m}_{Throt} is the throttle mass flow rate.

19. The internal combustion engine of claim 18, wherein the engine controller is programmed to determine a hybrid weight factor as a function of the EGR rate.

20. The internal combustion engine of claim 19, wherein the hybrid EGR mass flow rate is expressed as follows:
\dot{m}_{HPE}_{_{Hyb}}=K_{Hyb}\dot{m}_{HPE}_{_{Orif}}+(1−K_{Hyb})\dot{m}_{HPE}_{_{VolEff}}
where:
K_{Hyb} is the hybrid weight factor;
\dot{m}_{HPE}_{_{Orif}} is the first EGR mass flow rate; and
\dot{m}_{HPE}_{_{VolEff}} is the second EGR mass flow rate.
